(19) United States
(12) Patent Application Publication
(10) Pub. No.: US 2010/0147332 A1
(43) Pub. Date: Jun. 17, 2010

(54) SYSTEM AND METHOD FOR PIPELINE CLEANING USING CONTROLLED INJECTION OF GAS

(75) Inventors: Lee D. Rhyne, Cypress, TX (US); James R. Stoy, Houston, TX (US)

Correspondence Address: CHEVRON CORPORATION, P.O. BOX 6006, SAN RAMON, CA, 94583-0806, US

(73) Assignee: CHEVRON U.S.A. INC

(21) Appl. No.: 12/336,165

(22) Filed: Dec. 16, 2008

(51) Int. Cl. F16L 55/24; B08B 9/053

(52) U.S. Cl. 134/22.12; 134/166 C; 138/103

(57) ABSTRACT

A method of cleaning sediment from a liquid-transporting pipeline comprises injecting gas into the pipeline. The injected gas forms a bubble in the pipeline and the bubble travels in a direction towards a discharge of the pipeline. Resulting turbulence at a trailing surface of the bubble causes sediment in the pipeline to become entrained in a liquid phase trailing the bubble. The bubble and sediment entrained in a liquid phase trailing the bubble are conveyed to the discharge of the pipeline.

### BACKGROUND

Many pipelines, particularly those which convey fluids produced from wells, suffer from accumulation of sediment and/or liquid, which can reduce operating efficiency of the pipeline or even fully occlude the pipeline. Traditionally these pipelines are cleaned using “pig”, a solid bullet-like device, which is inserted into the pipeline and used to sweep the accumulated matter ahead of the pig. The pig is propelled through the pipeline using the same fluid that is ordinarily flowing. Ideally, the pig pushes sediment to a discharge of the pipeline, thereby removing the accumulated sediment from the pipeline. Pigs, which are available in a variety of shapes, sizes and configurations, can get stuck in the pipeline. Pigs used to displace sediment from liquid-conveying pipelines are particularly vulnerable to getting stuck because sediment accumulating ahead of the pig increases the resistance of the pig to forward movement. It is sometimes possible to free a stuck pig by reversing the direction of travel of the pig. This operation can be time consuming, and the pipeline is out of service until the pig can be recovered. Sometimes the accumulation of sediment ahead of the pig can be sufficient that mechanical bridging of sediment completely prevents the pig from moving further. When this occurs, reversing the direction of travel of the pig may not be effective to remove the pig and/or the obstruction of accumulated sediment, and the pipeline may even have to be cut open to remove the obstruction and the pig.

Expensive repairs, downtime and clean-out operations can potentially be avoided if sediment can be removed from the pipeline while the pipeline remains in-service. However, in order to “pig” a pipeline with the pipeline in-service, an elaborate mechanical and hydraulic apparatus is required to “launch” and “receive” the pig without imposing a disruption in the flow of fluids in the pipeline. The pig launcher and pig receiver represent a significant expenditure of capital resources, and these devices can sometimes be troublesome in operation. Furthermore, the pipeline is usually operated at reduced flow rates while a pig is in the pipeline.

A continued need exists for an improved system and method for cleaning accumulations, either solid or liquid, from a pipeline while the pipeline remains in-service, e.g., without operating at reduced rates, without the potential of a stuck pig, and/or without the use of pig launchers.

### SUMMARY

Provided is a system and method for cleaning accumulated material from a pipeline. These accumulations can be solid sediments or, e.g., in the case of gas transport pipelines, these accumulations can also be liquids. The method can include rapidly injecting gas into the pipeline. The injected gas forms a bubble in the pipeline, and the bubble travels in a direction towards a discharge of the pipeline. The gas bubble and accumulation entrained in a liquid phase trailing the bubble are conveyed to the discharge of the pipeline. Since this method does not involve solid pigs, there is no potential for a stuck pig.

While the present invention is not intended to be limited to any particular theory of operation, it is believed that the gas bubble can generally act in either of two fashions. First, in a gas dominated pipeline (i.e., a pipeline that primarily carries gas but which may also carry some liquid and/or solids), a gas bubble can be used to displace liquid ahead of the bubble, thereby resulting in the creation of a slug of liquid ahead of (i.e., downstream of) the bubble. The liquid slug can be highly turbulent, and that turbulence can entrain sediment. Furthermore, that liquid slug can continue to entrain liquid as it traverses the length of the pipeline. This can result in the removal of accumulated sediment and/or liquid from the pipeline. Second, in a liquid dominated pipeline (i.e., a pipeline that primarily carries liquid but which may also carry some gas and/or solids), multiple gas bubbles can be injected in rapid succession. The liquid slugs between the bubbles can be highly turbulent and can entrain sediment at the front of each liquid slug (i.e., at the tail of each gas bubble).

### BRIEF DESCRIPTION OF THE FIGURES OF THE DRAWING

FIG. 1 illustrates a system for removing solid sediments from a liquid-filled pipeline.

FIG. 2 illustrates a system for removing solid sediments from a liquid-dominated pipeline with bubbly flow.

FIG. 3 illustrates a system for removing liquid from a gas-dominated pipeline with stratified flow.

### DETAILED DESCRIPTION

Provided is an improved method to clean accumulated material, i.e., sediment and/or liquid, from a fluid-transporting pipeline while the pipeline remains in-service by injecting gas (e.g., pressurized gas) into the pipeline. The gas creates a disturbance in the liquid flow of the pipeline such that sediment and/or liquid accumulated in the pipeline becomes entrained in the flowing liquid in the pipeline and the accumulated sediment and/or liquid is removed from the pipeline at a discharge of the pipeline.

Sediment and/or liquid can accumulate in a pipeline, for example, at a low point or section in a pipeline that otherwise extends along a generally horizontal path, or at a point or section in a pipeline where flow in the pipeline changes to a direction that is slanted relatively upward from horizontal (such as a point or section in the pipeline where flow in the pipeline changes from a downward slanted orientation to an upward slanted orientation). As used herein, the phrase “generally horizontal” means no more than 70 degrees from horizontal. In some cases, the pipeline can be even more horizontal, e.g., no more than 45 degrees from horizontal, or no more than 20 degrees from horizontal.

Thus, in the presently disclosed method of cleaning accumulations from a generally horizontal, fluid-transporting pipeline, a flow of fluid is provided into the pipeline via a first inlet of the pipeline and through the pipeline toward a discharge. Gas is injected into the pipeline via a second inlet of the pipeline to form a bubble in the pipeline, such that the bubble travels in a direction toward the discharge of the pipeline with a liquid slug adjacent the bubble, and with turbulence at an end of the bubble causing accumulations in the pipeline to become entrained in the slug and conveyed with the slug to the discharge of the pipeline.

Similarly, the presently disclosed system for cleaning accumulations from a generally horizontal, fluid-transporting pipeline comprises a pipeline and an inlet in the pipeline for injecting gas into the pipeline to form a bubble in the pipeline, such that the bubble travels in a direction toward a discharge of the pipeline with a liquid slug adjacent the bubble, and with turbulence at an end of the bubble causing accumulations in the pipeline to become entrained in the slug and conveyed with the slug to the discharge of the pipeline.

Additionally provided is a pipeline comprising an inlet for injecting gas into the pipeline to form a bubble in the pipeline, such that the bubble travels in a direction toward a discharge of the pipeline with a liquid slug adjacent the bubble, and with turbulence at an end of the bubble causing accumulations in the pipeline to become entrained in the slug and conveyed with the slug to the discharge of the pipeline; a gas source fluidly connected to the inlet for injecting gas into the pipeline (e.g., via a valve); and a controller that can initiate injection of gas into the pipeline via the inlet for injecting gas into the pipeline.

In one embodiment, a quantity of gas is rapidly injected into a pipeline. The quantity and speed of injection of gas injected can be a function of the size of the pipeline and normal flow rates. In some cases, the gas forms a bubble that occupies the entire cross section of the pipeline, and/or the bubble can have a length (as measured in the longitudinal direction of the pipeline) that is significant in relation to the diameter of the pipeline. For example, the bubble can have a length that is at least five times the inside diameter of the pipeline and, in some cases, at least 10 times the inside diameter of the diameter of the pipeline.

The gas bubble moves along the pipeline and causes a liquid slug flow regime to occur locally. In other words, the leading and/or trailing ends of the bubble can be defined by a liquid slug made up of liquid flowing in the pipe adjacent the bubble. Resulting turbulence at the front end of the liquid slug causes suspension and entrainment of sediment in the pipeline in the liquid phase of the slug.

In particular, the injected bubble in a liquid-dominated pipeline can form slug flow locally. In this situation, the displacement of the liquid with a gas bubble causes an acceleration of the flow in the line. At the trailing end of the bubble, the liquid can form a shape that is a breaking wave that travels down the pipeline. The breaking wave, associated turbulence and bubbles, and the circular motion of that wave causes the sediment to be scoured from the bottom of the pipe and entrained in the trailing liquid slug. The use of multiple injected bubbles can facilitate effective transport of the sediment and reduces the amount of subsequent settling.

In an embodiment, the Froude number of the bubble is greater than about 2, for example, in the range of about 9-12. The Froude number is a non-dimensional number comparing inertial and gravitational forces and is defined as V/SQRT(gL), where V is the velocity of the bubble, g is the acceleration due to gravity, and L is the length (or height) of the bubble. While a Froude number of approximately 2 may be necessary to remove a top layer of sediment accumulated in a pipeline, a Froude number in the range of about 9-12 may be necessary to remove deeper layers of sediment accumulated in a pipeline.

Once entrained, sediment is conveyed with the liquid phase in the pipeline to a discharge of the pipeline. The length of the bubble, which is a function of the quantity of gas injected and the cross section of the pipeline, determines the intensity of the turbulence, with longer bubbles causing more displacement and acceleration. The discharge of the pipeline can simply be a large vessel to collect entrained sediment, liquid phase, and gas, wherein gas is allowed to separate from the liquid. The gas can be vented through a relief valve in the large vessel.

In some cases, an environmentally safe gas such as nitrogen or argon can be used, in which case the gas can be vented to atmosphere. In oil pipelines, high pressure natural gas can also be used. In an embodiment, the gas is a deoxygenated gas.

Relative to other methods that use a mechanical pig, this method provides a bubble with a low likelihood of ever getting stuck. The size of the bubble can easily be varied by adjusting the quantity of gas injected into a pipeline at minimal additional expense. The bubble launcher can simply be a valve connected to an up-stream segment of the pipeline, which injects gas into the pipeline. Current technology even allows for a valve to be installed while a pipeline is in-service (a “hot-tap” valve). The gas used can be 100% environmentally safe (e.g., nitrogen). In an embodiment, the bubble is formed by injected nitrogen liquid into the pipeline, the nitrogen liquid rapidly vaporizing to gas in the pipeline.

The present method allows for no disruption of flow in the pipeline, and many bubbles can be inserted into the pipeline in quick succession based on length of the pipeline and operational constraints. In particular, insertion of many bubbles into the pipeline in quick succession can provide successive scouring and enhanced entrainment and transport of the sediment.

The turbulent slug/plug flow which results from the bubble(s) in the pipeline is much less abrasive on the pipeline than the use of a mechanical device (i.e., pig), thereby reducing the risk of pipeline failure. Additionally, pressure in the pipeline during the present method of cleaning the pipeline can easily be held below a maximum allowable operating pressure, thereby reducing the possibility of pipeline rupture.

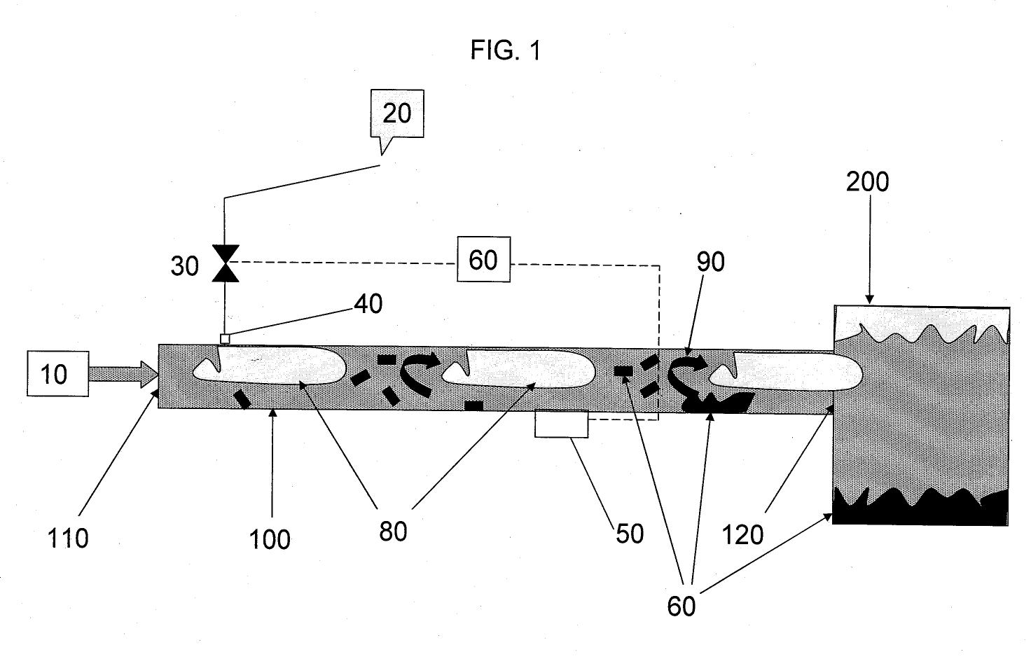

Specifically, FIG. 1 illustrates a system for removing solid sediments from a liquid-filled pipeline. Fluid source 10 (e.g., well providing production fluid) is fed into pipeline 100 via first inlet 110. High pressure gas 20 is injected via valve 30 (e.g., a simple Schrader valve which can be installed via hot tape) through port 40 (i.e., a second inlet) into pipeline 100. Detector 50 can automatically detect accumulations 60 (e.g., sand) in pipeline 100 and signal a human operator to perform a cleaning operation (or alternatively, automatically trigger controller 70 that can initiate the cleaning operation by opening valve 30). In an embodiment, detector 50 can detect changes in pressure (or pressure loss over the length of pipeline 100) that are indicative of accumulations 60 and required cleaning. Injection of high pressure gas 20 into pipeline 100 causes a bubble 80 to form in pipeline 100. Bubble 80 travels in a direction toward discharge 120 of pipeline 100, with a liquid slug adjacent bubble 80, and turbulence 90 at an end of bubble 80 causing accumulations 60 in pipeline 100 to become entrained in the slug and conveyed with the slug to discharge 120 of the pipeline. As illustrated in FIG. 1, discharge 120 can lead to separator 200 (e.g., a large vessel).

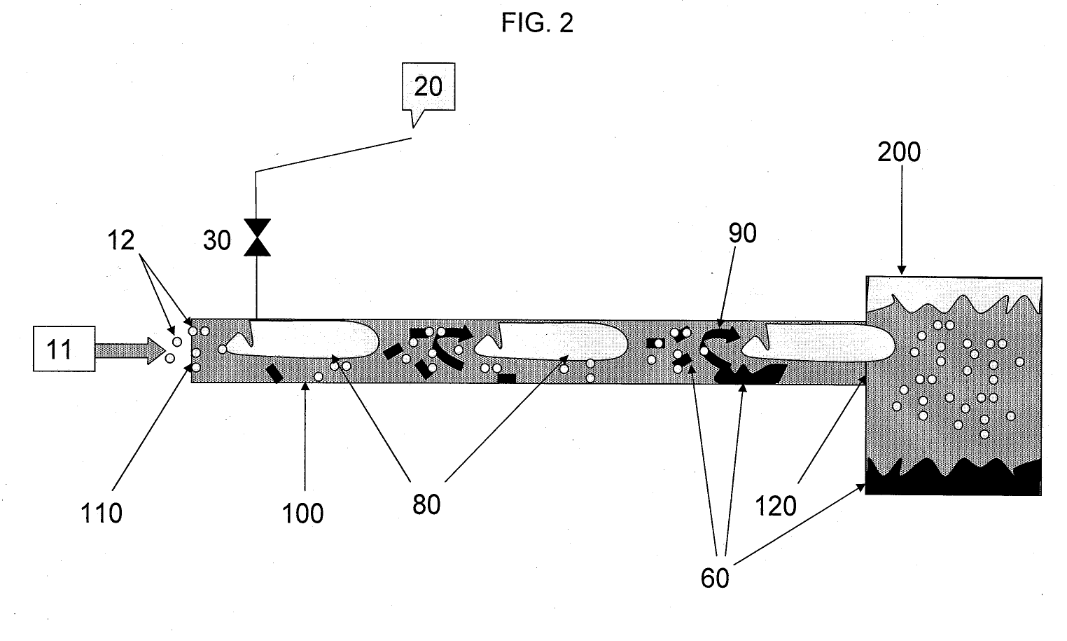

FIG. 2 illustrates a system for removing solid sediments from a liquid-dominated pipeline with bubbly flow. Fluid source 11 (e.g., well providing production fluid including bubbly flow 12) is fed into pipeline 100 via first inlet 110. High pressure gas 20 is injected via valve 30 (e.g., a simple Schrader valve which can be installed via hot tape) through a second inlet into pipeline 100. Injection of high pressure gas 20 into pipeline 100 causes a bubble 80 to form in pipeline 100. Bubble 80 travels in a direction toward discharge 120 of pipeline 100, with a liquid slug adjacent bubble 80, and turbulence 90 at an end of bubble 80 causing accumulations 60 in pipeline 100 to become entrained in the slug and conveyed with the slug to discharge 120 of the pipeline. As illustrated in FIG. 2, discharge 120 can lead to separator 200 (e.g., a large vessel).

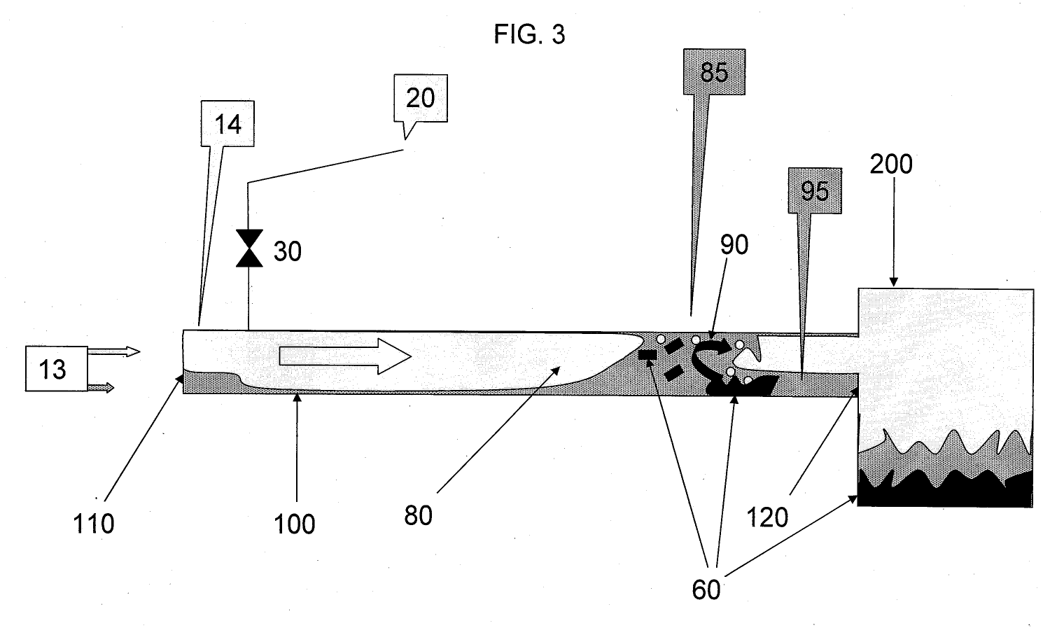

FIG. 3 illustrates a system for removing liquid from a gas-dominated pipeline with stratified flow. Fluid source 13 (e.g., well providing production fluid including gas) is fed into pipeline 100 via first inlet 110. Original gas level 14 in pipeline 100 following addition of the fluid source 12 into pipeline 100 is changed by injection of high pressure gas 20 via valve 30 (e.g., a simple Schrader valve which can be installed via hot tape) through a second inlet into pipeline 100. Injection of high pressure gas 20 into pipeline 100 causes a bubble 80 to form in pipeline 100. Bubble 80 travels in a direction toward discharge 120 of pipeline 100, with liquid slug 85 adjacent bubble 80, and turbulence 90 at an end of bubble 80 causing liquid accumulations 60 in pipeline 100 to become entrained in the slug and conveyed with the slug to discharge 120 of the pipeline. Original liquid level 95 is shown prior to discharge 120, which, as illustrated in FIG. 3, can lead to separator 200 (e.g., a large vessel).

In an embodiment, the liquid-transporting pipeline can be flow lines of a sub sea well, connecting one or more wellbores to a host facility. Injection of gas into flow lines of a sub sea well can help maintain late-life production from long offset sub sea gas wells, as the ability to maintain late-life production from long offset sub sea gas wells is dependent on the ability of the well stream to reduce flow line pressure by effectively sweeping, for example, liquids from the flow line. Liquid hold-up in a long line can cause excessive pressure drop and high manifold pressure, causing reduced production from wells.

According to one embodiment of the present invention, high pressure, high volume dehydrated gas is compressed or otherwise provided at the host facility and delivered through one flow line to the production manifold, through the sub sea pigging loop, and back to the host facility via the second flow line, thereby sweeping the liquids from the flow lines. The removal of liquids can allow the wells to continue flowing.

According to some embodiments of the present invention, systems having pipes of nonuniform internal diameters can be pigged in one operation and/or with the same slugs successively passing therethrough. In this regard, it is noted that subsea pigging of flow lines, e.g., flow lines that connecting wells to manifolds and manifolds to pipelines and pipelines to risers, are often characterized by varying internal diameters as necessitated by material strength, economic considerations, and/or other considerations. In some cases, the embodiments of the present invention can accommodate even extreme variations in internal diameter, unlike conventional pigging methods. In fact, constraints on internal diameter, along with the need for a roundtrip or subsea pig launcher, typically result in conventional subsea pigging methods to be used for pigging the main trunk flow lines only, and very seldom used for subsea tiebacks of wells to manifolds. Such constraints are not present for the method described herein.

While various embodiments have been described, it is to be understood that variations and modifications may be resorted to as will be apparent to those skilled in the art. Such variations and modifications are to be considered within the purview and scope of the claims appended hereto.

What is claimed is:

1. A method of cleaning accumulations from a generally horizontal, fluid-transporting pipeline, the method comprising:
providing a flow of fluid into the pipeline via a first inlet of the pipeline and through the pipeline toward a discharge; and
injecting gas into the pipeline via a second inlet of the pipeline to form a bubble in the pipeline, such that the bubble travels in a direction toward the discharge of the pipeline with a liquid slug adjacent the bubble, and with turbulence at an end of the bubble causing accumulations in the pipeline to become entrained in the slug and conveyed with the slug to the discharge of the pipeline.

2. The method of claim 1, wherein injecting gas into the pipeline comprises forming the bubble with a length greater than five times a diameter of the pipeline.

3. The method of claim 2, wherein injecting gas into the pipeline comprises injecting at least three bubbles, each bubble separated by a slug having a length greater than ten times a diameter of the pipeline.

4. The method of claim 1, wherein injecting gas into the pipeline comprises forming the bubble to occupy the entire cross section of the pipeline.

5. The method of claim 1, further comprising discharging the bubble, slug, and accumulation from the discharge of the pipeline to a separator and separating different phases of the bubble, slug, and accumulation in the separator.

6. The method of claim 1, wherein the gas comprises at least one of the group consisting of argon and nitrogen.

7. The method of claim 1, wherein injecting gas into the pipeline comprises injecting liquid nitrogen into the pipeline, such that the nitrogen liquid vaporizes to form gas in the pipeline.

8. The method of claim 1, further comprising providing a gas source fluidly connected to the second inlet of the pipeline via a valve, and wherein injecting gas into the pipeline comprises opening the valve to inject the gas from the gas source into the pipeline.

9. A system for cleaning accumulations from a generally horizontal, fluid-transporting pipeline, the system comprising:
a pipeline; and
an inlet in the pipeline for injecting gas into the pipeline to form a bubble in the pipeline, such that the bubble travels in a direction toward a discharge of the pipeline with a liquid slug adjacent the bubble, and with turbulence at an end of the bubble causing accumulations in the pipeline to become entrained in the slug and conveyed with the slug to the discharge of the pipeline.

10. The system of claim 9, further comprising a gas source fluidly connected to the inlet for injecting gas into the pipeline via a valve.

11. The system of claim 10, wherein the valve is installed in the pipeline while the pipeline is in-service.

12. The system of claim 9, wherein the bubble has a Froude number of greater than about 2.

13. The system of claim 9, further comprising a detector for detecting accumulations in the pipeline.

14. The system of claim 13, further comprising a controller that can initiate injection of gas into the pipeline via the inlet for injecting gas into the pipeline.

15. The system of claim 14, wherein the controller initiates injection of gas into the pipeline via the inlet for injecting gas into the pipeline based on accumulations in the pipeline detected by the detector.

16. The system of claim 13, wherein injection of gas into the pipeline via the inlet for injecting gas into the pipeline is based on accumulations in the pipeline detected by the detector.

17. The system of claim 9, wherein the bubble has a length greater than five times a diameter of the pipeline.

18. The system of claim 9, wherein the bubble occupies the entire cross section of the pipeline.

19. The system of claim 9, further comprising a separator into which the bubble, slug, and accumulation are discharged from the discharge of the pipeline.

20. A pipeline comprising:
an inlet for injecting gas into the pipeline to form a bubble in the pipeline, such that the bubble travels in a direction toward a discharge of the pipeline with a liquid slug adjacent the bubble, and with turbulence at an end of the bubble causing accumulations in the pipeline to become entrained in the slug and conveyed with the slug to the discharge of the pipeline;
a gas source fluidly connected to the inlet for injecting gas into the pipeline; and
a controller that can initiate injection of the gas into the pipeline via the inlet for injecting gas into the pipeline.

21. The pipeline of claim 20, wherein the gas source is fluidly connected to the inlet for injecting gas into the pipeline via a valve.

22. The pipeline of claim 20, further comprising a detector for detecting accumulations in the pipeline.

23. The pipeline of claim 20, further comprising a separator into which the bubble, slug, and accumulation are discharged from the discharge of the pipeline.
